(19) United States
(12) Patent Application Publication
(10) Pub. No.: US 2023/0147937 A1
(43) Pub. Date: May 11, 2023

(54) IMPACT RING

(71) Applicant: GM Global Technology Operations LLC, Detroit, MI (US)

(72) Inventors: Tsau Yueh Wang, Rochester Hills, MI (US); Li L. Sun, Novi, MI (US)

(21) Appl. No.: 17/524,034

(22) Filed: Nov. 11, 2021

(51) Int. Cl. F21S 45/10; F21S 43/20

(52) U.S. Cl. CPC F21S 45/10; F21S 43/26

(57) ABSTRACT

A lamp protection assembly includes a lamp assembly that includes a lens, a lamp housing, and one or more lighting elements located within the lamp housing. The one or more lighting elements being configured to emit light through the lens. The lamp protection assembly also includes an impact ring that is configured to wrap around the lens.

The subject disclosure relates to lamps of vehicles, and more particularly relates to an impact ring to protect lamps in the fascia of the rear-ends and other areas of the vehicles.

The rear-end structure (and front-end structure) of vehicles are relatively complex assemblies and include numerous parts and pieces. There are many reasons for this, including both styling and functional reasons. One functional reason is because the vehicle rear-end structures and associated bumper/fascia systems must not only be able to resist damage upon low-speed impacts, but must also allow the bumper to stroke, crush, and absorb substantial energy upon high-energy impacts, while still permitting the structure to anchor and uniformly support fascia in and around the bumper and the lamps, during normal vehicle operation. Typically, this is accomplished by using a variety of brackets, flanges, and braces that support the fascia in various areas, and mount to different parts of the vehicle structures.

### SUMMARY

In one exemplary embodiment, a lamp protection assembly is provided. The lamp protection assembly includes a lamp assembly that includes a lens, a lamp housing, and one or more lighting elements located within the lamp housing. The one or more lighting elements being configured to emit light through the lens. The lamp protection assembly also includes an impact ring that is configured to wrap around the lens.

In addition to one or more of the features described herein, or as an alternative, further embodiments may include that the impact ring is composed of a first material having a first young's modulus and the lens is composed of a second material having a second young's modulus that is greater than the first young's modulus.

In addition to one or more of the features described herein, or as an alternative, further embodiments may include that the impact ring protrudes further away from the lamp protection assembly than the lens.

In addition to one or more of the features described herein, or as an alternative, further embodiments may include that the impact ring protrudes further away from the lamp protection assembly than the lens.

In addition to one or more of the features described herein, or as an alternative, further embodiments may include that the lens further includes a raised lens face having an edge extending thereabout. The impact ring is configured to wrap around the outer surface of the edge.

In addition to one or more of the features described herein, or as an alternative, further embodiments may include that the lamp assembly further includes a flange configured to attach the lens to the lamp housing. The edge extends from the flange to the lens face.

In addition to one or more of the features described herein, or as an alternative, further embodiments may include that the impact ring further includes an inner surface, an outer surface located opposite the inner surface, and a radially inward surface extending from the inner surface to the outer surface. The radially inward surface is configured to wrap around the edge.

In addition to one or more of the features described herein, or as an alternative, further embodiments may include that the edge has a first height as measured from the flange to the lens face. The impact ring has a second height as measured from the inner surface to the outer surface. The second height being greater than the first height.

In addition to one or more of the features described herein, or as an alternative, further embodiments may include that the impact ring is composed of a first material having a first young's modulus and the lens is composed of a second material having a second young's modulus that is greater than the first young's modulus.

In addition to one or more of the features described herein, or as an alternative, further embodiments may include that the lens is composed of a first lens portion composed of a first lens material and a second lens portion composed of a second lens material.

In another exemplary embodiment, a vehicle is provided. The vehicle including a fascia, a lamp port formed in the fascia, and a lamp protection assembly mounted within the lamp port. The lamp protection assembly includes a lamp assembly that includes a lens, a lamp housing, and one or more lighting elements located within the lamp housing. The one or more lighting elements being configured to emit light through the lens. The lamp protection assembly also includes an impact ring that is configured to wrap around the lens.

In addition to one or more of the features described herein, or as an alternative, further embodiments may include that the impact ring is composed of a first material having a first young's modulus and the lens is composed of a second material having a second young's modulus that is greater than the first young's modulus.

In addition to one or more of the features described herein, or as an alternative, further embodiments may include that the impact ring protrudes outwardly from a lens face of the lens.

In addition to one or more of the features described herein, or as an alternative, further embodiments may include that the impact ring protrudes outwardly from a lens face of the lens.

In addition to one or more of the features described herein, or as an alternative, further embodiments may include that the lens further includes a raised lens face having an edge extending thereabout. The impact ring is configured to wrap around the outer surface of the edge.

In addition to one or more of the features described herein, or as an alternative, further embodiments may include that the lamp assembly further comprises a flange configured to attach the lens to the lamp housing. The edge extends from the flange to the lens face.

In addition to one or more of the features described herein, or as an alternative, further embodiments may include that the impact ring further includes an inner surface, an outer surface located opposite the inner surface, and a radially inward surface extending from the inner surface to the outer surface. The radially inward surface is configured to wrap around the edge.

In addition to one or more of the features described herein, or as an alternative, further embodiments may include that the edge has a first height as measured from the flange to the lens face. The impact ring has a second height as measured from the inner surface to the outer surface. The second height being greater than the first height.

In addition to one or more of the features described herein, or as an alternative, further embodiments may include that the impact ring is composed of a first material having a first young's modulus and the lens is composed of a second material having a second young's modulus that is greater than the first young's modulus.

In another exemplary embodiment, a method of fabricating a lamp protection assembly for a vehicle is provided. The method includes obtaining a lamp assembly for the vehicle. The lamp assembly includes a lamp assembly that includes a lens, a lamp housing, and one or more lighting elements located within the lamp housing. The one or more lighting elements being configured to emit light through the lens. The method further includes wrapping an impact ring around the lens.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a rear perspective view of a vehicle that includes a lamp assembly with an impact ring to form a lamp protection assembly, according to an embodiment of the present disclosure;

FIG. 2 is a disassembled view of the lamp protection assembly of FIG. 1, according to an embodiment of the present disclosure;

FIG. 3 is an isometric view of the lamp protection assembly of FIG. 1, according to an embodiment of the present disclosure;

FIG. 4 is an enlarged cross-sectional view of a hollow impact ring, according to an embodiment of the present disclosure;

FIG. 5 is an enlarged cross-sectional view of a solid impact ring, according to an embodiment of the present disclosure;

FIG. 6 is a side view of the vehicle with the lamp protection assembly about to strike an object, according to an embodiment of the present disclosure;

FIG. 7 is a flow diagram illustrating a method of fabricating the lamp protection assembly, according to an embodiment of the present disclosure.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Lamps may be located in the rear fascia of a vehicle which exposes them to impacts during collisions with stationary object or another vehicle. The lamps are typically composed of one or more delicate materials that may crack or shatter upon impact. The embodiments disclosed herein seek to provide an impact ring to encircle an outer perimeter of the lamp with a young's modulus that is less than a young's modulus of the lens of the lamp it is protecting. The impact ring is proud of the lens of the lamp in the vehicle so that it extends further outward away from the vehicle to better protect the lens during impacts.

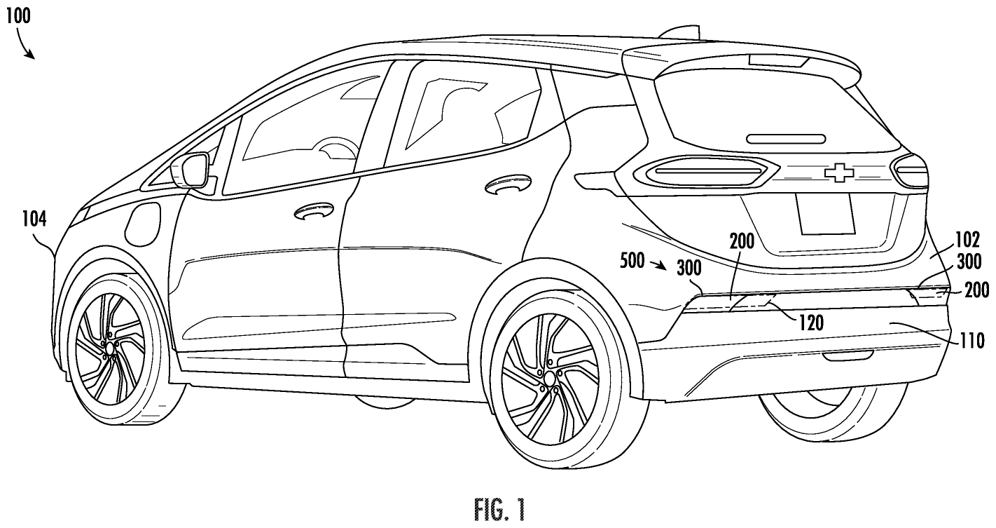

Referring now to FIG. 1, a rear perspective view of a vehicle 100 is illustrated, according to an embodiment of the present disclosure. The vehicle 100 includes a lamp protection assembly 500 formed by an impact ring 300 and a lamp assembly 200. The impact ring 300 wraps around the lamp assembly 200. The lamp protection assembly 500 may be located on a rear end 102 of the vehicle 100. Typically, lamp assemblies 200 are “mirror images” of each other and, therefore, the following description applies equivalently to either a left side assembly or a right side assembly. Lamp assemblies 200 may also be found on other areas of the vehicle 100, including, but not limited to, the front end 104 of the vehicle 100, therefore, the following description applies equivalently to a lamp assembly 200 located on any other areas of the vehicle 100.

The lamp protection assembly 500 may be mounted within suitably sized lamp ports 120 formed within the body or a rear fascia 110 of vehicle 100. For example, such lamp ports 120 may be formed within the rear fascia 110 of the vehicle 100 proximate a bumper of the vehicle 100. The rear fascia 110 may be described as the ornamental and/or structural outer surface of the vehicle 100 that is integrally attached to the bumper and/or the frame (not shown) of the vehicle 100.

The impact ring 300 is configured to encircle the lamp assembly 200 to protect the lamp assembly 200 in the event of a collision as discussed further herein. The impact ring 300 is configured to extend further away from the rear fascia 110 than the lamp assembly 200 to protect the lamp assembly 200 in the event of a collision as discussed further herein.

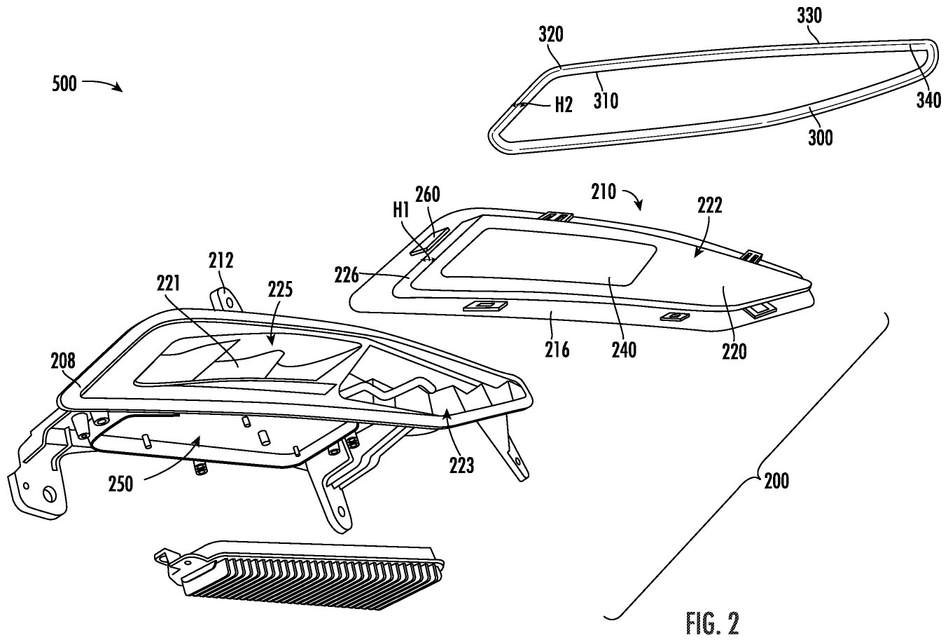

Referring now to FIG. 2, with continued reference to FIG. 1, a disassembled view of the lamp protection assembly 500 is illustrated in accordance with an embodiment of the present disclosure. The lamp assembly 200 is composed of a lamp housing 208 and a lens 210. The lens 210 may include a first lens portion 240 and a second lens portion 220. The lens 210 includes a lens face 222 that includes a segment of the second lens portion 220 and the first lens portion 240. It is understood that the embodiments described herein may also be applicable to a lens 210 having only one lens portion and not a different first lens portion 240 and second lens portion 220. The first lens portion 240 and the second lens portion 220 may have different colors and transparencies, as discussed further herein.

The lamp housing 208 is configured to attach the lamp assembly 200 to the vehicle 100. The lamp housing 208 may include one or more attachment arms 212 to operably attach the lamp assembly 200 to a bumper of the vehicle 100, a structural frame of the vehicle 100, and/or a rear fascia 110 of the vehicle 100. The lamp housing 208 is configured to attach the lamp assembly 200 to the vehicle 100 through the one or more attachment arms 212.

The lamp housing 208 may have one or more chambers which may include a first chamber 223 and a second chamber 225. The lamp assembly 200 includes one or more lighting elements 250 located within the lamp housing 208. The one or more lighting elements are configured to emit light through the lens 210. The lighting elements 250 will shine from the chambers 223, 225, through the first lens portion 240 or the second lens portion 220, independently, for different usage, such as, for example, backing up, stopping, or turning. The lamp housing 208 may include any number of lighting elements 250. The lighting elements 250 may be an electrified lamp such as a light emitting diode (LED) light bulb, an incandescent light bulb, or any other similar light emitting device known to one of skill in the art. The lamp assembly 200 may include a reflector 221 located within the lamp housing 208. The reflector 221 is configured to reflect light produced by the lighting elements 250. The reflector 221 may be located in the second chamber 225. The lens 210 encloses the lighting elements 250 and/or the reflector 221 within the one or more chambers 223, 225, thus protecting the lighting elements 250 and/or the reflectors 221 from the external environment.

The first lens portion 240 may be composed of a first lens material that is transparent, semi-transparent, or translucent material to allow light generated by the lighting elements 250 or light reflected by the reflector 221 to pass through the first lens portion 240. In one embodiment, the first lens portion 240 is formed from a clear plastic material or tempered glass.

The second lens portion 220 may be composed of a second material that is transparent, semi-transparent, or translucent material to allow light generated by the lighting elements 250 or light reflected by the reflector 221 to pass through the second lens portion 220. In one embodiment, the second lens portion 220 is formed from a clear plastic material or tempered glass. The second material may be different from the first lens material. The second material may have a different transparency than the first lens material.

The lens 210 includes a flange 216 extending about its perimeter. The second lens portion 220 of the lens 210 may include the flange 216. The flange 216 is configured to attach the lens 210 to the lamp housing 208. The flange 216 may be glued or sonic welded to the lamp housing 208. The lens face 222 extends outwardly from the flange 216 as illustrated in FIG. 2. The lens face 222 is joined to the flange by an edge 226. The second lens portion 220 of the lens 210 may include the edge 226. The outer surface 226 is configured to mate flush with the impact ring 300.

The edge 226 extends from the flange 216 to the lens face 222. The edge 226 connects to the lens face 222 to the flange 216. The edge 226 has a first height H1 that is measured from the flange to the lens face 222. It is understood that the edge 226 may or may not be present, and the embodiment disclosed herein may be applicable to lens 210 with or without the edge 226.

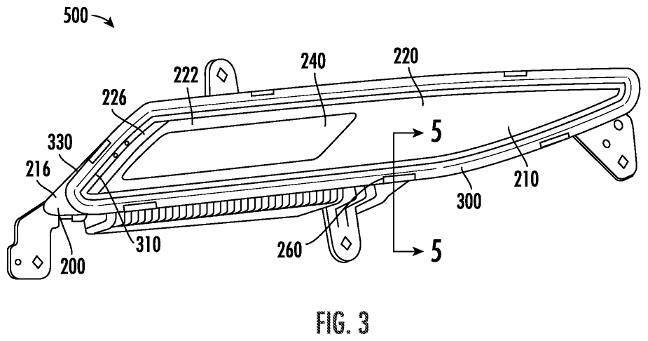

The impact ring 300 is separate from the lamp assembly 200. The impact ring 300 is configured to wrap around the lens 210. More specifically, the impact ring 300 may be configured to wrap around the lens face 222 and/or the edge 226. The impact ring 300 may be held in place by one or more tabs 260 extending outwardly from the flange 216 and space from the edge 226. Upon installation into the vehicle 100, the impact ring 300 may be covered by the rear fascia 110 of the vehicle 100 and the rear fascia 110 may also help secure the impact ring 300 in place. More specifically, the impact ring 300 is configured to wrap around the edge 226 of the lens 210. The impact ring 300 includes a radially inward surface 310, a radially outward surface 320 located opposite the radially inward surface 310, an inner surface 330, and an outer surface 340 located opposite the inner surface 330. The radially inward surface 310 extends from the inner surface 330 to the outer surface 340. The radially outward surface 320 extends from the inner surface 330 to the outer surface 340. The radially inward surface 310 of the impact ring 300 is configured to wrap around or engage the edge 226, as illustrated in FIG. 3.

The impact ring 300 has a second height H2 that is measured from the inner surface 330 to the outer surface 340. The second height H2 is greater than the first height H1 of the edge 226, thus the impact ring 300 protrudes further from the vehicle 100 and/or the lamp protection assembly 500 than the lens face 222. In other words, the impact ring 300 extends further from the flange 216 than the lens face 222. In an alternative embodiment, the lamp assembly 200 may not include a flange 216 and the impact ring 300 may rest on the edge 226.

When assembled to the lens 210, the impact ring 300 is configured to extend outwardly past the lens face 22 at a height of H2. The projection of the impact ring 300 beyond the lens face 222 will transfer an impact load away from the lends face 222 during an impact with the lens protection assembly 500.

Referring now to FIG. 3, with continued reference to FIGS. 1-2, a perspective view of the impact ring 300 assembled onto the lamp assembly 200 to comprise the lamp protection assembly 500 is illustrated in accordance with an embodiment of the present disclosure. As illustrated in FIG. 3, the inner surface 330 of the impact ring 300 mates flush onto the flange 216 and the radially inward surface 310 of the impact ring 300 mates flush with the edge 226. The impact ring 300 wraps around the lens 210. More specifically, the impact ring 300 wraps around the edge 226. Even more specifically, the radially inward surface 310 of the impact ring 300 wraps around the edge 226.

In an embodiment, the impact ring 300 is composed of a first material having a first young's modulus and the lens 210 is composed of a second material having a second young's modulus that is greater than the first young's modulus. In other words, the first young's modulus is less than the second young's modulus. As a result, the impact ring 300 will be softer or more flexible than the lens 210. In an embodiment, the first material that the impact ring 300 is composed of may be a plastic, or a similar material known to one of skill in the art. The impact ring 300 may be hollow or solid. In an embodiment, the second material that the lens 210 is composed of may be a clear plastic material, tempered glass, or a similar material known to one of skill in the art. Advantageously, the impact ring 300 has a lower young's modulus and is softer, which helps spread impact force on the lamp assembly 500. In the embodiment illustrated, the second lens portion 220 may be composed of the second material having the second young's modulus, since the second lens portion 220 is in contact with the impact ring 300. As aforementioned, the first lens portion 240 may be composed of a first lens material and the second lens portion 220 may be composed of the second lens material, thus the second lens material may be equivalent to the second material.

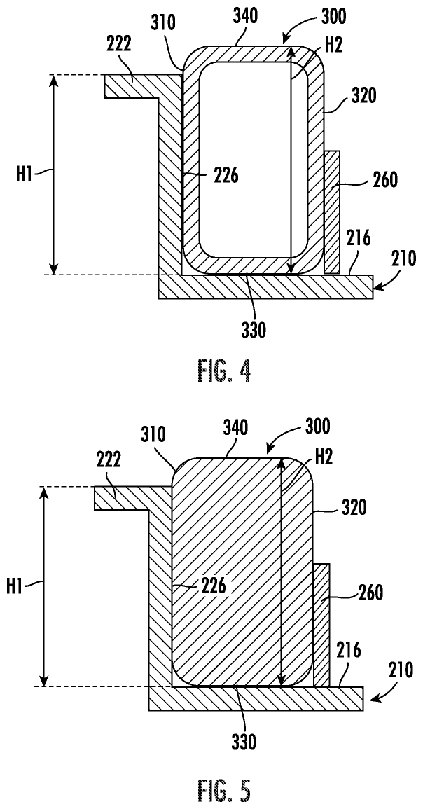

Referring to FIGS. 4 and 5, with continued reference to FIGS. 1-4, an enlarged cross-sectional view of the impact ring 300 assembled on to the lens 210 is illustrated, in accordance with embodiments of the present disclosure. The impact ring 300 illustrated in FIG. 4 is hollow, whereas the impact ring illustrated in FIG. 5 is solid.

As aforementioned, the lens 210 may include a raised lens face 222 connected to the flange 216 via an edge 226. The edge 226 has a first height H1 that is measured from the flange 216 to the lens face 222. It is understood that while lens 210 is described and illustrated herein as having a flange 216, the embodiments described herein are also applicable to a different lens without the flange 216.

The impact ring 300 is configured to wrap around the lens 210 or more specifically the lens face 222. Even more specifically, the impact ring 300 is configured to wrap around the edge 226.

The radially inward surface 310 may be configured to mate flush with the edge 226. The radially inward surface 310 may be operably shaped to match a shape of the edge 226. The impact ring 300 and is configured to absorb, dissipate, and/or transfer an impact load to the lens 210 during an impact.

The inner surface 330 may be configured to mate flush with the flange 216. The inner surface 330 may be operably shaped to match a shape of the flange 216. In an embodiment, the inner surface 330 and the flange 216 each have a flat or planar in shape. In an alternative embodiment, there may be no flange 216.

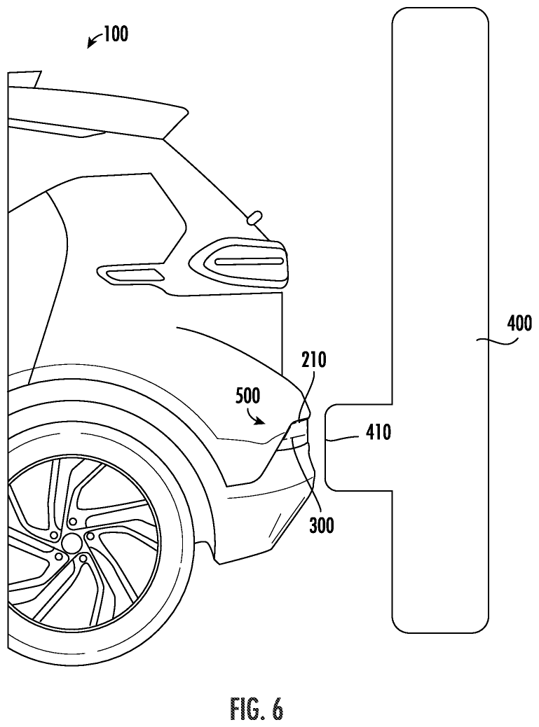

Referring now to FIG. 6, with continued reference to FIGS. 1-5, a side view of the vehicle 100 with the lamp protection assembly 500 about to impact a stationary object 400 at an impact point 410 is illustrated in accordance with an embodiment of the present disclosure. As previously mentioned, the impact ring 300 protrudes further away from the vehicle 100 than the lens 210. The impact ring 300 also protrudes further way from the lamp assembly 200 than the lens 210. Advantageously, since the impact ring 300 extends further away from the vehicle 100, in the event of a collision between a vehicle 100 and of the stationary object 400, the impact ring 300 will strike the impact point 410 prior to the lens 210 striking the impact point 410. Thus, the impact ring 300 will absorb a majority of the force from the impact with the impact point 410. Advantageously, this will help spread the force from the impact around the impact ring 300 and protect the lens 210 from breaking during impact. Also, advantageously, the impact ring 300 will help spread the force from the impact ring 300 more evenly through the lens 210, thus reducing the risk that the lens 210 will break during impact.

Also, advantageously, the impact ring 300 manages impact energy more efficiently than current systems, which results in a smaller offset between the rear fascia 110 of the vehicle 100 and the lens 210 to absorb the impact force. This in turn will enable more flexibility to the design. This results in less off-set between a surface of rear fascia 110 and a surface of the lens 210 if desired. The impact ring 300 can also function as a decorative bezel piece around the rear fascia 110, the lens 210, or any other sensor of the vehicle 100.

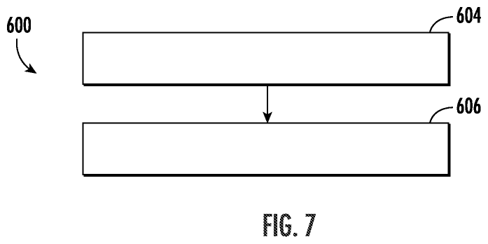

Referring to FIG. 7, with continued reference to FIGS. 1-6, a method 600 of fabricating a lamp protection assembly 500 for a vehicle 100 is illustrated, in accordance with an embodiment of the present disclosure.

At block 604, a lamp assembly 200 for the vehicle 100 is obtained.

The lamp assembly 200 includes a lens 210, a lamp housing 208, and one or more lighting elements 250 located within the lamp housing 208. The one or more lighting elements 250 are configured to emit light through the lens 210.

At block 606, an impact ring 300 is wrapped around the lens 210.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A lamp protection assembly for a vehicle, the lamp protection assembly comprising:
a lamp assembly comprising:
a lens;
a lamp housing; and
one or more lighting elements located within the lamp housing, the one or more lighting elements being configured to emit light through the lens; and
an impact ring configured to wrap around the lens;
wherein the impact ring protrudes further away from the lamp protection assembly than the lens in a light emission direction of the one or more lighting elements;
wherein the lens further comprises a raised lens face having an edge extending thereabout,
wherein the impact ring is configured to wrap around the edge;
wherein the impact ring is disposed between the edge and one or more tabs, the one or more tabs configured to retain the impact ring to the lens.

2. The lamp protection assembly of claim 1, wherein the impact ring is composed of a first material having a first young's modulus and the lens is composed of a second material having a second young's modulus that is greater than the first young's modulus.

3. (canceled)

4. (canceled)

5. (canceled)

6. The lamp protection assembly of claim 1, wherein the lamp assembly further comprises a flange configured to attach the lens to the lamp housing, wherein the edge extends from the flange to the lens face.

7. The lamp protection assembly of claim 1, wherein the impact ring further comprises:
an inner surface;
an outer surface, the outer surface located further from the one or more lighting elements than the inner surface, relative to the light emission directions of the one or more lighting elements; and
a radially inward surface extending from the inner surface to the outer surface,
wherein the radially inward surface is configured to wrap around the edge.

8. The lamp protection assembly of claim 7, wherein the edge has a first height as measured from the flange to the lens face, and
wherein the impact ring has a second height as measured from the inner surface to the outer surface, the second height being greater than the first height.

9. The lamp protection assembly of claim 8, wherein the impact ring is composed of a first material having a first young's modulus and the lens is composed of a second material having a second young's modulus that is greater than the first young's modulus.

10. (canceled)

11. A vehicle, comprising:
a fascia;
a lamp port formed in the fascia; and
a lamp protection assembly mounted within the lamp port, the lamp protection assembly comprising:
a lamp assembly comprising:
a lens;
a lamp housing; and
one or more lighting elements located within the lamp housing, the one or more lighting elements being configured to emit light through the lens; and
an impact ring configured to wrap around the lens;
wherein the impact ring protrudes further away from the lamp assembly than the lens in a light emission direction of the one or more lighting elements;
wherein the lens further comprises a raised lens face having an edge extending thereabout,
wherein the impact ring is configured to wrap around the edge;
wherein the impact ring is disposed between the edge and one or more tabs, the one or more tabs configured to retain the impact ring to the lens.

12. The vehicle of claim 11, wherein the impact ring is composed of a first material having a first young's modulus and the lens is composed of a second material having a second young's modulus that is greater than the first young's modulus.

13. The vehicle of claim 12, wherein the impact ring protrudes outwardly from a lens face of the lens.

14. The vehicle of claim 11, wherein the impact ring protrudes outwardly from a lens face of the lens.

15. (canceled)

16. The vehicle of claim 11, wherein the lamp assembly further comprises a flange configured to attach the lens to the lamp housing, wherein the edge extends from the flange to the lens face.

17. The vehicle of claim 11, wherein the impact ring further comprises:
an inner surface;
an outer surface located opposite the inner surface, the outer surface located further from the one or more lighting elements than the inner surface, relative to the light emission directions of the one or more lighting elements; and
a radially inward surface extending from the inner surface to the outer surface,
wherein the radially inward surface is configured to wrap around the edge.

18. The vehicle of claim 17, wherein the edge has a first height as measured from the flange to the lens face, and
wherein the impact ring has a second height as measured from the inner surface to the outer surface, the second height being greater than the first height.

19. The vehicle of claim 18, wherein the impact ring is composed of a first material having a first young's modulus and the lens is composed of a second material having a second young's modulus that is greater than the first young's modulus.

20. A method of fabricating a lamp protection assembly for a vehicle, the method comprising:
obtaining a lamp assembly for the vehicle, the lamp assembly comprising:
a lens;
a lamp housing; and
one or more lighting elements located within the lamp housing, the one or more lighting elements being configured to emit light through the lens; and
wrapping an impact ring around the lens;
wherein the impact ring protrudes further away from the lamp assembly than the lens in a light emission direction of the one or more lighting elements;
wherein the lens further comprises a raised lens face having an edge extending thereabout,
wherein the impact ring is configured to wrap around the edge;
wherein the impact ring is disposed between the edge and one or more tabs, the one or more tabs configured to retain the impact ring to the lens.

21. The lamp protection assembly of claim 1, wherein the impact ring is hollow.
